(19) United States
(12) Patent Application Publication
(10) Pub. No.: US 2025/0166307 A1
(43) Pub. Date: May 22, 2025

(54) CONTROLLING DEPTH SENSITIVITY IN CONDITIONAL TEXT-TO-IMAGE

(71) Applicant: ADOBE INC., SAN JOSE, CA (US)

(72) Inventors: Matheus Gadelha, San Jose, CA (US); Kevin James Blackburn-Matzen, Seattle, WA (US); Radomir Mech, Los Altos, CA (US)

(21) Appl. No.: 18/948,089

(22) Filed: Nov. 14, 2024

Related U.S. Application Data
(60) Provisional application No. 63/600,813, filed on Nov. 20, 2023.

(51) Int. Cl. G06T 19/00

(52) U.S. Cl. CPC G06T 19/00

(57) ABSTRACT

A method, apparatus, non-transitory computer readable medium, and system for image processing include obtaining a condition input and an adherence parameter, where the condition input indicates an image attribute and the adherence parameter indicates a level of the condition input, generating an intermediate output based on the condition input and the adherence parameter, where the intermediate output includes the image attribute, and generating a synthetic image based on the intermediate output, where the synthetic image includes the image attribute based on the level indicated by the adherence parameter.

### CROSS-REFERENCE TO RELATED APPLICATION

This application claims priority under 35 U.S.C. § 119 to U.S. Provisional Application No. 63/600,813, filed on Nov. 20, 2023, in the United States Patent and Trademark Office, the disclosure of which is incorporated by reference herein in its entirety.

### BACKGROUND

The following relates generally to image processing, and more specifically to image generation using a machine learning model. Image processing refers to the use of a computer to edit an image using an algorithm or a processing network. In some cases, image processing software can be used for various image processing tasks, such as image editing, image restoration, image detection, and image generation. For example, image generation includes the use of a machine learning model to generate an image based on a dataset. In some cases, the machine learning model is trained to generate a synthetic image based on a text, a color, a style, or an image.

### SUMMARY

Aspects of the present disclosure provide methods, non-transitory computer readable media, apparatuses, and systems for image processing. According to an aspect of the present disclosure, a two-step process is used to generate a synthetic image (or output image) based on a text prompt and an adherence parameter (e.g., a depth guidance value). For example, the first step of the two-step process includes using a first image generation model to generate an intermediate image based on a structure input and the adherence parameter.

In some cases, the first image generation model is trained to perform a reverse diffusion process for k iterations (e.g., a first diffusion timestep) based on the adherence parameter. The intermediate image includes features described by the adherence parameter. The second step of the two-step process includes using a second image generation model to generate the output image based on the intermediate image. For example, the second image generation model is trained to perform a reverse diffusion process for T−k iterations (e.g., a second diffusion time-step) based on the adherence parameter and the intermediate image to generate the output image. By training the model using the first diffusion step and the second diffusion step, the model can generate an output image that accurately reflects a depth feature based on the adherence parameter.

A method, apparatus, non-transitory computer readable medium, and system for image processing include obtaining a condition input and an adherence parameter, where the condition input indicates an image attribute and the adherence parameter indicates a level of the condition input, generating, using a first image generation model, an intermediate output based on the condition input and the adherence parameter, where the intermediate output includes the image attribute, and generating, using a second image generation model, a synthetic image based on the intermediate output, where the synthetic image includes the image attribute based on the level indicated by the adherence parameter.

A method, apparatus, non-transitory computer readable medium, and system for image processing include obtaining a condition input and an adherence parameter; generating, using a first diffusion process, an intermediate output based on the condition input, wherein the first diffusion process is performed for a first number of timesteps based on the adherence parameter; and generating, using a second diffusion process, a synthetic image based on the intermediate output.

A method, apparatus, non-transitory computer readable medium, and system for image processing are described. One or more aspects of the method, apparatus, non-transitory computer readable medium, and system include obtaining training data including a structure input and a ground truth image corresponding to the structure input; training a first image generation model to generate images with a target structure based on the structure input based on the ground truth image; and generating, using a second image generation model, an output image, where an output of the first image generation model is used as input of the second image generation model.

An apparatus, system, and method for image processing are described. One or more aspects of the apparatus, system, and method include at least one processor; at least one memory storing instructions executable by the at least one processor; a first image generation model comprising parameters stored in the at least one memory and trained to generate an intermediate image based on a structure input; and a second image generation model comprising parameters stored in the at least one memory and trained to generate an output image, where the second image generation model is configured to generate the output image based on the intermediate image and an adherence parameter, and where the output image depicts an object with a structure based on the structure input.

### BRIEF DESCRIPTION OF THE DRAWINGS

FIG. 1 shows an example of figure description according to aspects of the present disclosure.

FIG. 2 shows an example of a method for generating a synthetic image based on depth control according to aspects of the present disclosure.

FIG. 3 shows an example of text-to-image generation according to aspects of the present disclosure.

FIG. 4 shows an example of condition image generation according to aspects of the present disclosure.

FIG. 5 shows an example of a user interface with a depth control element according to aspects of the present disclosure.

FIG. 6 shows an example of a method for generating a synthetic image according to aspects of the present disclosure.

FIG. 7 shows an example of an image processing apparatus according to aspects of the present disclosure.

FIG. 8 shows an example of a machine learning model according to aspects of the present disclosure.

FIG. 9 shows an example of a ControlNet architecture according to aspects of the present disclosure.

FIG. 10 shows an example of an image generation model according to aspects of the present disclosure.

FIG. 11 shows an example of a U-Net architecture according to aspects of the present disclosure.

FIG. 12 shows an example of a diffusion process according to aspects of the present disclosure.

FIG. 13 shows an example of a method for training a diffusion model according to aspects of the present disclosure.

FIG. 14 shows an example of a computing device according to aspects of the present disclosure.

### DETAILED DESCRIPTION

Aspects of the present disclosure relate to text-to-image generation using generative machine learning. Some embodiments of the disclosure relate to an image generation system that accurately generates images that align with an input text prompt based on an input adherence parameter. In some aspects, the system includes a first image generation model trained to generate an intermediate output that adheres to a condition input based on the adherence parameter, and a second image generation model configured to generate a synthetic image based on the intermediate output of the first image generation model. The intermediate output generated by the first image generation model is provided to the second image generation model to ensure that the overall structure of the image adheres to the condition input based on the adherence parameter while preserving the ability of the system to generate variations on the details.

According to aspects of the disclosure, a two-stage process is used to generate a synthetic image (or output image) based on a text prompt and an adherence parameter (e.g., a depth guidance value). For example, the first stage of the two-stage process includes using a first image generation model to generate an intermediate output based on a structure input and the adherence parameter. In some cases, the first image generation model is trained to perform a reverse diffusion process for k iterations (e.g., a first diffusion timestep) based on the adherence parameter. The intermediate output includes features described by the structure input.

The second stage of the two-stage process includes using a second image generation model to generate the output image based on the intermediate output. For example, the second image generation model is trained to perform a reverse diffusion process based on the intermediate output for T−k iterations (e.g., a second diffusion time-step) indicated by the adherence parameter to generate the output image. By configuring the system to perform reverse diffusion processing using the two-stage process (e.g., the first diffusion step and the second diffusion step), the system can generate a synthetic image that accurately reflects a depth feature based on the condition input that adheres to the adherence parameter.

A subfield in image generation relates to text-to-image generation using a ControlNet. In some cases, conventional image generation models are trained to generate synthetic images based on additional controls such as depth information. However, by simply conditioning the additional control of depth information into a diffusion model, the quality of the synthetic image might not be accurately represented by the depth information.

In some cases, a ControlNet receives the additional control of depth information (e.g., a depth value) to guide a diffusion model to generate the synthetic image. The ControlNet predicts residual features that are added to intermediate layers of a UNet of the diffusion model. These residual features are multiplied by a single scalar value (e.g., a scalar weight) ranging between [0,1]. For example, 0 indicates no depth guidance and 1 indicates full depth guidance. However, this conventional technique ignores other depth information from other conditionings. As a result, the synthetic image does not accurately reflect the depth information in the synthetic image.

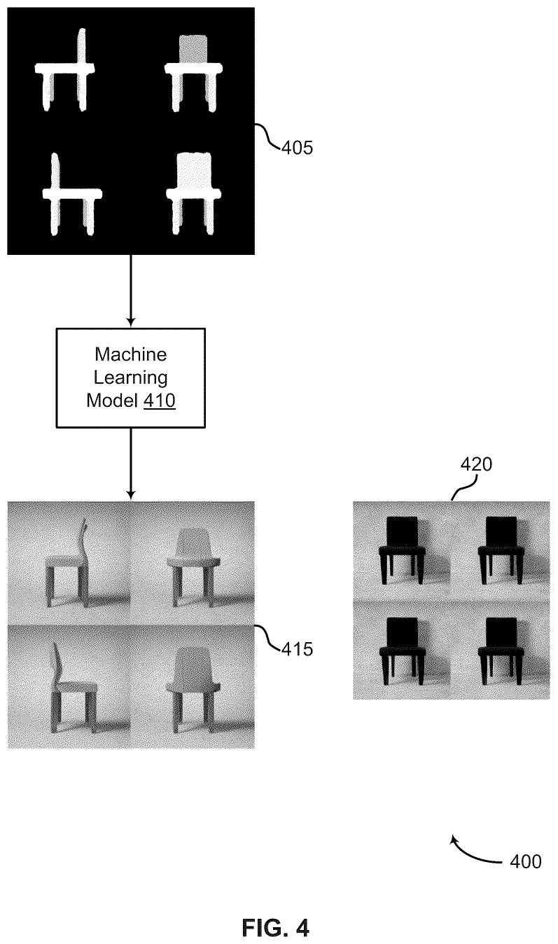

In some cases, the conventional system generates images that poorly reflect the depth information. For example, given a text prompt (or a structure input) and an adherence parameter (e.g., a depth guidance value), the conventional system may generate an image that does not reflect the structure input due to the predominant depth guidance. For example, as shown in FIG. 4, the conventional system generates a set of conventional output images each having the same orientation due to the predominant depth guidance. In some cases, the conventional system may generate additional features (such as shadows or reflections) that represent the depth guidance while ignoring the depth of the element described by the text prompt.

Accordingly, the present disclosure provides systems and methods that improve on conventional image generation models by accurately generating a synthetic image that aligns with a condition input. This is achieved using a system that includes a first image generation model trained to generate an intermediate output based on a condition input that adheres to the adherence parameter, and a second image generation model configured to generate a synthetic image based on the intermediate output.

Aspects of the present disclosure further include a user interface comprising a structural adherence control element. For example, the structural adherence control element enables a user to easily navigate and control the amount of depth guidance to a structure input. In some cases, a higher value of the adherence parameter indicates the synthetic image is generated based on stronger depth guidance. In some cases, a lower value of the adherence parameter indicates the synthetic image is generated to include additional detail features that are not represented by the depth information.

In some cases, the system of the present disclosure can be used to generate synthetic images based on additional conditioning, such as style conditioning or image conditioning, without additional training. For example, the first image generation model of the disclosure is trained to generate an intermediate output based on the structure input and depth guidance. In some cases, the first image generation model includes a ControlNet and a U-Net. In some cases, the first image generation model is fine-tuned. In some cases, the second image generation model is trained to generate a synthetic image based on the intermediate output generated from the first image generation model. By not conditioning the second image generation model with depth conditioning, the system of the present disclosure can generate the output image reflecting additional depth features with additional depth information, for example, from text conditioning. Additionally, fine details of the synthetic image can be generated by the second image generation model.

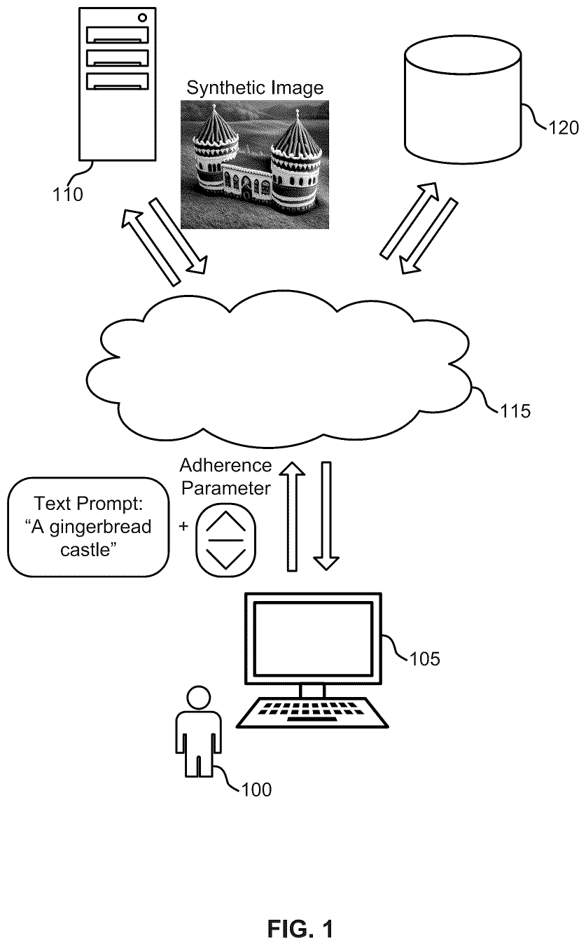

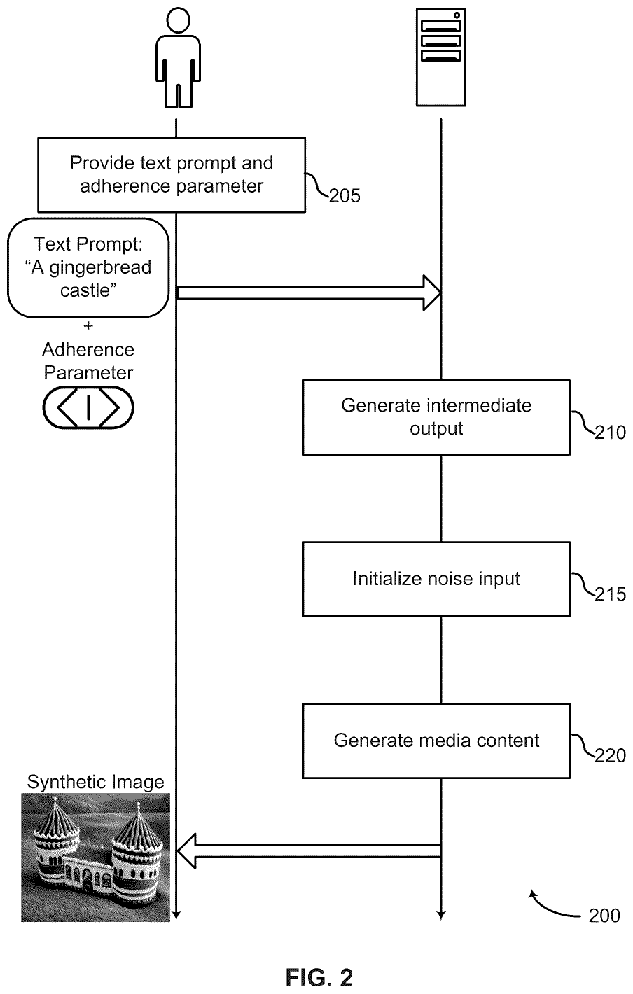

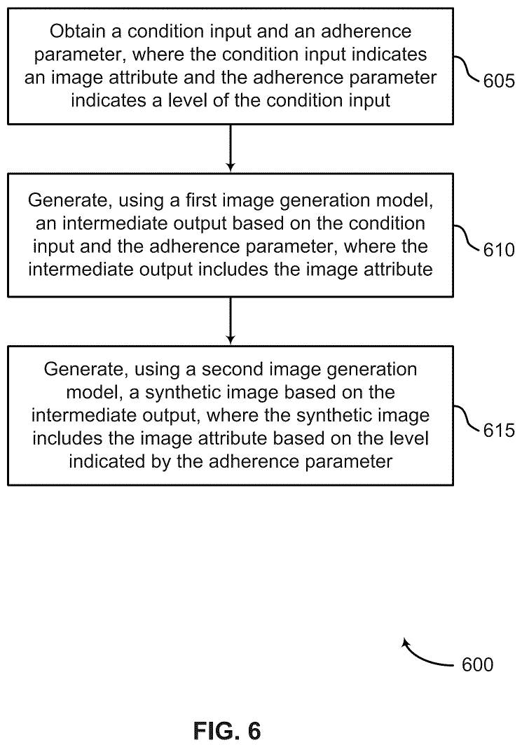

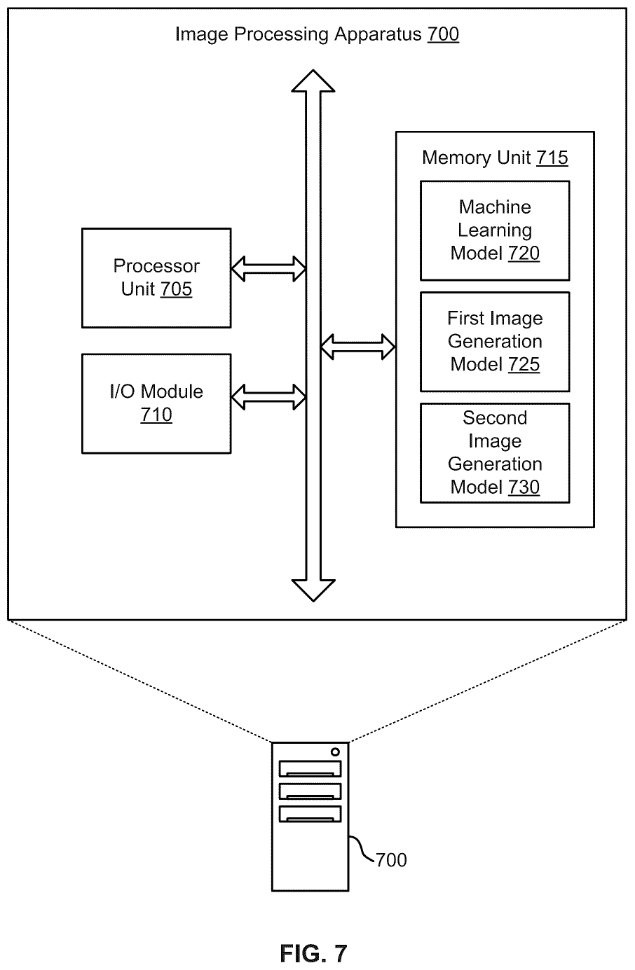

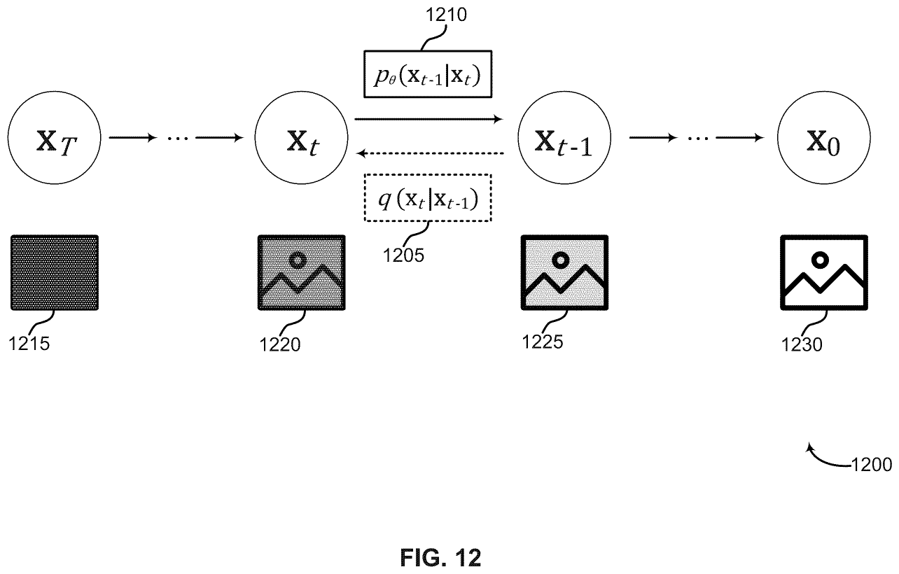

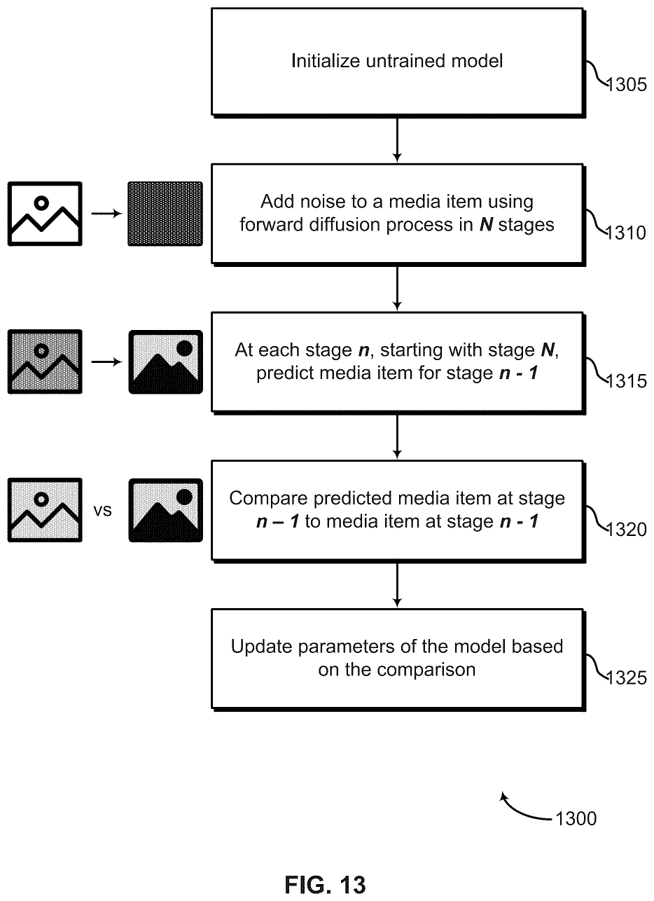

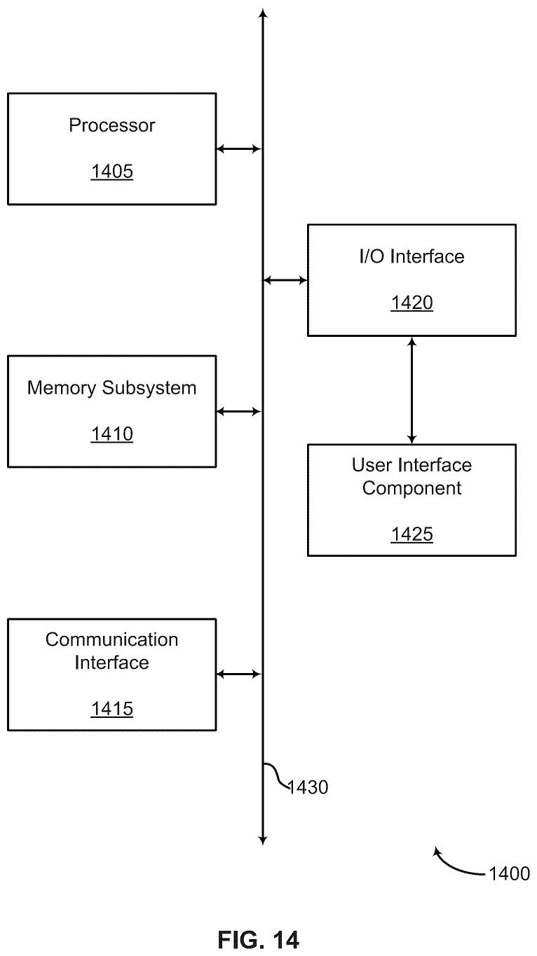

An example system of the inventive concept in image processing is provided with reference to FIGS. 1 and 14. An example application of the inventive concept in image processing is provided with reference to FIGS. 2-5. Details regarding the architecture of an image processing apparatus are provided with reference to FIGS. 7-11. An example of a process for image processing is provided with reference to FIGS. 6 and 12. A description of an example training process is provided with reference to FIG. 13.

Accordingly, embodiments of the present disclosure enhance image processing applications such as text-to-image generation, visual art design, storyboarding, and content creation by generating synthetic images that depict an accurate and realistic depth of the structure input. For example, by using the two image generation models, the system is not predominantly conditioned on depth information. Additionally, the system of the present disclosure can generate a synthetic image that accurately depicts the depth information. Additionally or alternatively, the system can be used to generate synthetic images based on additional conditioning, such as style conditioning or image conditioning, without additional training.

### Image Processing

In FIGS. 1-6 and 12, a method, apparatus, non-transitory computer readable medium, and system for image processing include obtaining a condition input and an adherence parameter, where the condition input indicates an image attribute and the adherence parameter indicates a level of the condition input, generating, using a first image generation model, an intermediate output based on the condition input and the adherence parameter, where the intermediate output includes the image attribute, and generating, using a second image generation model, a synthetic image based on the intermediate output, where the synthetic image includes the image attribute based on the level indicated by the adherence parameter.

Some examples of the method, apparatus, non-transitory computer readable medium, and system further include obtaining a 3D model of an object. Some examples further include generating a depth map based on the 3D model, where the condition input comprises the depth map and the image attribute comprises a shape of the object. Some examples of the method, apparatus, non-transitory computer readable medium, and system further include generating a plurality of layer-specific features based on the condition input. Some examples further include providing the plurality of layer-specific features to a plurality of corresponding layers of the first image generation model, respectively.

Some examples of the method, apparatus, non-transitory computer readable medium, and system further include determining a timestep threshold based on the adherence parameter. Some examples further include performing, using the first image generation model, a first diffusion process before the timestep threshold. Some examples of the method, apparatus, non-transitory computer readable medium, and system further include performing, using the second image generation model, a second diffusion process after the timestep threshold.

Some examples of the method, apparatus, non-transitory computer readable medium, and system further include computing a product of a total number of timesteps and the adherence parameter. Some examples of the method, apparatus, non-transitory computer readable medium, and system further include obtaining a text prompt, where the synthetic image is generated based on the text prompt.

A method, apparatus, non-transitory computer readable medium, and system for image processing are described. One or more aspects of the method, apparatus, non-transitory computer readable medium, and system include obtaining a structure input and an adherence parameter indicating a level of adherence to the structure input; generating, using a first image generation model, an intermediate output based on the structure input; and generating, using a second image generation model, an output image based on the intermediate output and the adherence parameter, where the output image depicts an object with a structure based on the structure input.

Some examples of the method, apparatus, non-transitory computer readable medium, and system further include obtaining a 3D model. Some examples further include generating a depth map based on the 3D model, where the structure input comprises the depth map. Some examples of the method, apparatus, non-transitory computer readable medium, and system further include receiving a user input via a structural adherence control element of a user interface, where the adherence parameter is based on the user input.

Some examples of the method, apparatus, non-transitory computer readable medium, and system further include determining a first diffusion timestep based on the adherence parameter, where the intermediate output comprises an output of the first image generation model at the first diffusion timestep. Some examples of the method, apparatus, non-transitory computer readable medium, and system further include determining a second diffusion timestep based on the adherence parameter. Some examples further include performing a reverse diffusion process with the second image generation model using the intermediate output as input at the second diffusion timestep.

Some examples of the method, apparatus, non-transitory computer readable medium, and system further include obtaining a text prompt, where the intermediate output and the output image are generated based on the text prompt. Some examples of the method, apparatus, non-transitory computer readable medium, and system further include obtaining a style input, where the output image is generated based on the style input. In some aspects, the first image generation model is trained using training data that includes structure inputs and ground truth images corresponding to the structure inputs, respectively.

FIG. 1 shows an example of figure description according to aspects of the present disclosure. The example shown includes user 100, user device 105, image processing apparatus 110, cloud 115, and database 120. Image processing apparatus 110 is an example of, or includes aspects of, the corresponding element described with reference to FIG. 7.

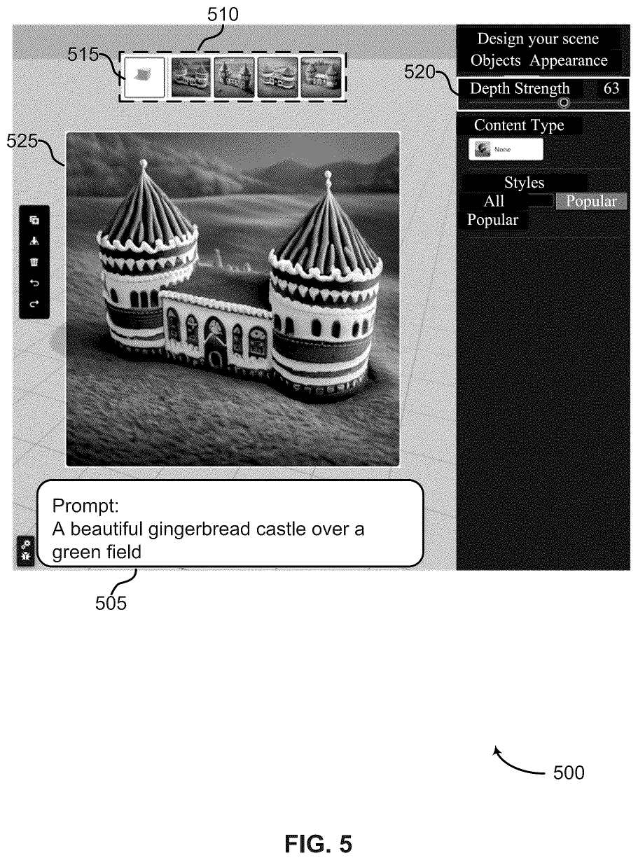

Referring to FIG. 1, user 100 provides a text prompt and an adherence parameter to image processing apparatus 110 via user device 105 and cloud 115. In some cases, the text prompt includes a sentence describing an element. For example, the text prompt states “A gingerbread castle.” In some cases, user 100 provides an adherence parameter (e.g., a depth guidance value) via a user interface provided by image processing apparatus 110. In some cases, the text prompt is a voiced-based statement or text-based statement. In some embodiments, the image processing apparatus 110 generates a structure input based on the text prompt. For example, the structure input represents a 3D model of the element described by the text prompt. In some cases, image processing apparatus 110 generates a synthetic image based on the text prompt, the structure input, and the adherence parameter. Image processing apparatus 110 generates a synthetic image representing the structure input. For example, the synthetic image depicts a gingerbread castle on top of a green field. In some cases, image processing apparatus 110 displays the synthetic image to user 100 via user device 105 and cloud 115. In some cases, image processing apparatus 110 displays the synthetic image to user 100 via a user interface (e.g., the user interface described with reference to FIG. 5) provided by image processing apparatus 110 or user device 105 via cloud.

User device 105 may be a personal computer, laptop computer, mainframe computer, palmtop computer, personal assistant, mobile device, or any other suitable processing apparatus. In some examples, user device 105 includes software that incorporates an image detection application. In some examples, the image detection application on user device 105 may include functions of image processing apparatus 110.

A user interface may enable user 100 to interact with user device 105. In some embodiments, the user interface may include an audio device, such as an external speaker system, an external display device such as a display screen, or an input device (e.g., a remote-controlled device interfaced with the user interface directly or through an I/O controller module). In some cases, a user interface may be a graphical user interface (GUI). In some examples, a user interface may be represented in code in which the code is sent to the user device 105 and rendered locally by a browser. The process of using the image processing apparatus 110 is further described with reference to FIG. 2. The processing of using the user interface is further described with reference to FIG. 6. The User interface is an example of, or includes aspects of, the corresponding element described with reference to FIG. 12.

Image processing apparatus 110 is an example of, or includes aspects of, the corresponding element described with reference to FIG. 7. According to some aspects, image processing apparatus 110 includes a computer implemented network comprising a machine learning model, a first image generation model, and a second image generation model. Image processing apparatus 110 further includes a processor unit, a memory unit, and an I/O module. In some cases, for example, image processing apparatus 110 includes a user interface and a training component. In some embodiments, image processing apparatus 110 further includes a communication interface and a bus as described with reference to FIG. 14. Additionally, image processing apparatus 110 communicates with user device 105 and database 125 via cloud 115. Further detail regarding the operation of image processing apparatus 110 is provided with reference to FIG. 2.

In some cases, image processing apparatus 110 is implemented on a server. A server provides one or more functions to users linked by way of one or more of the various networks. In some cases, the server includes a single microprocessor board, which includes a microprocessor responsible for controlling aspects of the server. In some cases, a server uses the microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user (e.g., user 100). The term cloud is sometimes used to describe data centers available to many users over the Internet. Some large cloud networks have functions distributed over multiple locations from central servers. A server is designated an edge server if the server has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

According to some aspects, database 120 stores a training dataset including a plurality of short text prompts and a plurality of images. In some cases, database 120 stores the training dataset. Database 120 is an organized collection of data. For example, database 120 stores data in a specified format known as a schema. Database 120 may be structured as a single database, a distributed database, multiple distributed databases, or an emergency backup database. In some cases, a database controller may manage data storage and processing in database 120. In some cases, a user (e.g., user 100) interacts with the database controller. In other cases, the database controller may operate automatically without user interaction.

FIG. 2 shows an example of a method 200 for generating a synthetic image based on depth control according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 205, the system provides text prompt and adherence parameter. In some cases, the operations of this step refer to, or may be performed by, a user as described with reference to FIG. 1. In some cases, for example, the text prompt is a sentence describing an element or an object. In some cases, the system generates a structure input based on the text prompt. In some cases, the system provides the structure input to the image processing apparatus. In some cases, the adherence parameter includes a depth value indicating an amount of depth guidance to the first image generation model.

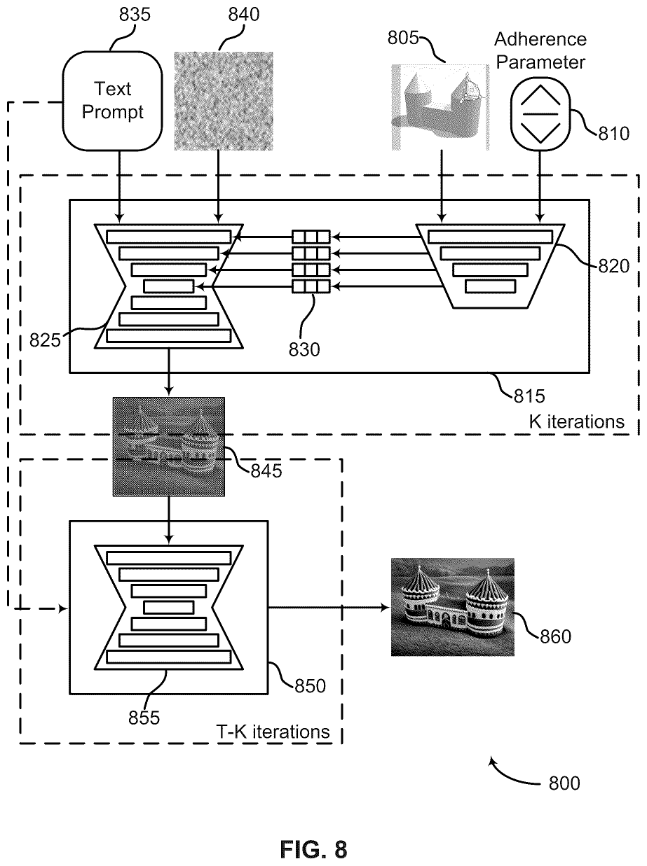

At operation 210, the system generates intermediate output. In some cases, the operations of this step refer to, or may be performed by, an image processing apparatus as described with reference to FIGS. 1 and 7. In some cases, the operations of this step refer to, or may be performed by, a first image generation model as described with reference to FIGS. 7 and 8. In some cases, for example, the first image generation model includes a ControlNet. The first image generation model generates an intermediate output based on the adherence parameter and the text prompt as conditionings. In some cases, the intermediate output includes a noisy image. In some cases, the intermediate output is generated based on a diffusion timestep.

At operation 215, the system initializes noise input. In some cases, the operations of this step refer to, or may be performed by, an image processing apparatus as described with reference to FIGS. 1 and 7. In some cases, the operations of this step refer to, or may be performed by, a first image generation model as described with reference to FIGS. 7 and 8. In some cases, the noise input including random noise is initialized. The noise input may be in a latent space. By initializing the first image generation model with random noise, different variations of the synthetic image including the content described by the text conditioning (e.g., the text prompt) can be generated.

At operation 220, the system generates media content. In some cases, the operations of this step refer to, or may be performed by, an image processing apparatus as described with reference to FIGS. 1 and 7. In some cases, the operations of this step refer to, or may be performed by, a second image generation model as described with reference to FIGS. 7 and 8. In some cases, for example, the media content includes a synthetic image. In some cases, for example, the second image generation model performs a second diffusion process on the intermediate output to obtain the synthetic image using the intermediate output as input. In some cases, the second diffusion process is further guided by the text prompt. In some cases, the synthetic image is displayed on a user device via a user interface of the image processing apparatus and cloud. For example, the synthetic image depicts a gingerbread house on a green field.

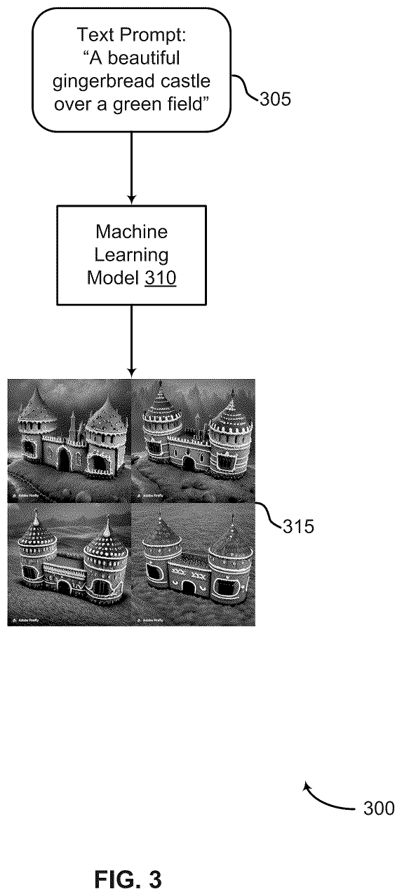

FIG. 3 shows an example of text-to-image generation according to aspects of the present disclosure. The example shown includes image generation system 300, text prompt 305, machine learning model 310, and synthetic images 315.

Referring to FIG. 3, machine learning model 310 receives text prompt 305 and generates synthetic images 315. For example, text prompt 305 states “A beautiful gingerbread castle over a green field.” In some cases, a user further provides a depth value (e.g., the adherence parameter) to machine learning model 310. In some cases, synthetic images 315 includes one or more images. For example, the upper left image of synthetic images 315 illustrates image generation with the least depth guidance. The upper right image of synthetic images 315 illustrates image generation with slightly more depth guidance than the previous image. The bottom left image of synthetic images 315 illustrates image generation with more depth guidance than the previous image. The bottom right image of synthetic images 315 illustrates image generation with the most depth guidance. In some cases, the more depth guidance the machine learning model 310 receives, the fewer detail features are generated to show the depth feature in the synthetic images 315.

Image generation system 300 is an example of, or includes aspects of, the corresponding element described with reference to FIG. 4. Text prompt 305 is an example of, or includes aspects of, the corresponding element described with reference to FIGS. 5, 8, and 10. Machine learning model 310 is an example of, or includes aspects of, the corresponding element described with reference to FIGS. 4 and 7. Synthetic images 315 is an example of, or includes aspects of, the corresponding element described with reference to FIG. 4.

FIG. 4 shows an example of condition image generation according to aspects of the present disclosure. The example shown includes image generation system 400, structure input 405, machine learning model 410, synthetic images 415, and conventional synthetic images 420.

Referring to FIG. 4, machine learning model 410 receives structure input 405 and generates synthetic images 415. In some cases, synthetic images 415 includes one or more images. In some cases, structure input 405 includes one or more structure inputs describing an element. For example, structure input 405 shows four different orientations of a chair each arranged in a quadrant. Machine learning model 410 generates synthetic images 415 comprising four orientations of a chair each arranged in the same orientation as the orientation shown in the structure input 405. Additionally, synthetic images 415 depicts the depth of the chair in different orientations based on a depth parameter (e.g., the adherence parameter). On the contrary, a conventional image generation model generates conventional synthetic images 420 that depict a chair in the same orientation. For example, the conventional image generation model is predominantly conditioned based on the depth information. In some cases, during the reverse diffusion process, the conventional image generation model is unable to generate fine details of a synthetic image due to the predominant conditioning on the scalar value (e.g., depth conditioning). Therefore, the conventional image generation model fails to generate images that include other depth features from other inputs, such as a text prompt or image prompt.

Image generation system 400 is an example of, or includes aspects of, the corresponding element described with reference to FIG. 3. Structure input 405 is an example of, or includes aspects of, the corresponding element described with reference to FIG. 5. Machine learning model 410 is an example of, or includes aspects of, the corresponding element described with reference to FIGS. 3 and 7. Synthetic images 415 is an example of, or includes aspects of, the corresponding element described with reference to FIG. 3.

FIG. 5 shows an example of a user interface 500 with a depth control element 520 according to aspects of the present disclosure. The example shown includes user interface 500, text prompt 505, thumbnail 510, structure input 515, depth control element 520, and synthetic image 525.

Referring to FIG. 5, user interface 500 displays a prompt box to receive text prompt 505 from, for example, a user. For example, text prompt 505 states “A beautiful gingerbread castle over a green castle.” Then, the user may adjust the depth guidance (e.g., the adherence parameter) by adjusting the slider of depth control element 520. In some cases, for example, the depth control element 520 is referred to as “Depth Strength.” In some cases, the higher the value of depth strength, the more depth guidance is introduced to the system (e.g., the first image generation model). In some cases, user interface 500 displays a thumbnail 510 in an upper region of the display of the user interface 500. The thumbnail 510 includes structure input 515 and a plurality of thumbnail synthetic images. In some embodiments, the structure input 515 is obtained via a 3D modeling application from the image processing apparatus described with reference to FIGS. 1 and 7. In some embodiments, the structure input 515 is provided by a user. Upon selecting an image from the plurality of thumbnail output images, synthetic image 525 is displayed via user interface 500.

Text prompt 505 is an example of, or includes aspects of, the corresponding element described with reference to FIGS. 3, 8, and 10. Structure input 515 is an example of, or includes aspects of, the corresponding element described with reference to FIG. 4. Synthetic image 525 is an example of, or includes aspects of, the corresponding element described with reference to FIG. 8.

FIG. 6 shows an example of a method 600 for generating a synthetic image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 605, the system obtains a condition input and an adherence parameter, where the condition input indicates an image attribute and the adherence parameter indicates a level of the condition input. In some cases, the operations of this step refer to, or may be performed by, a first image generation model as described with reference to FIGS. 7 and 8. In some cases, the condition input may be a form of data used to guide the image generation process. For example, the condition input may include text prompts, segmentation maps, style prompt, reference image, edge map, depth map, sketches, various forms of masks, or latent codes (or latent features). In some cases, the adherence parameter indicates how closely the output of the model follows the condition input. For example, the adherence parameter may include conditioning strength, guidance scale, weight map, noise injection, weight ratio, interpolation strength, or thresholding.

For example, the conditioning strength indicates how strongly the model adheres to the condition input, such as a text prompt, a segmentation map, or a structure map. In some cases, for example, higher strength parameter indicates that the output closely follows the condition input, and the lower strength parameter indicates free generation by the model. In some aspects, the guidance scale is used in text-to-image generation which controls the balance between following the text prompt and enable the model to generate diverse outputs free from the text prompt. In some cases, a high guidance scale results in image generation that is more closely aligned with the text. In some aspects, the weight map is used in mask-guided generation which assigns different levels of importance to various regions of the mask. For example, certain regions of the image may be adhered more strictly to the condition input, and other regions may vary more.

In some aspects, the noise injection controls the amount of noise added during the diffusion process. For example, fewer noise leads to closer adherence to the condition input, and more noise result in variations of the output. In some aspects, weight ratio may be used to determine the weights between two or more condition inputs. For example, when a text prompt and a structure input is provided to the model, the weight ratio determines how much each condition influences the final output. In some aspects, interpolation strength determines how much the model interpolates between different latent codes or reference styles. In some aspects, the thresholding is used in binary conditioning when masks or edge maps are used as condition inputs. For example, the model sets a threshold for how much deviation is allowed in the generated image based on the threshold.

At operation 610, the system generates, using a first image generation model, an intermediate output based on the condition input and the adherence parameter, where the intermediate output includes the image attribute. In some cases, the operations of this step refer to, or may be performed by, a first image generation model as described with reference to FIGS. 7 and 8. In some cases, the intermediate output may include an intermediate image (e.g., in pixel space) or an intermediate feature (e.g., in latent space). For example, the intermediate image may be a noisy image that depicts some visual elements such as basic shapes, colors, or patterns that the final output image (e.g., the synthetic image) may include. In some cases, for example, the intermediate image may depict the shapes and outline of objects, color blending of the image, texture and patterns of the image, partial visual features (such as face or object), and the global structure of the image.

In some cases, the intermediate feature may be a latent feature that represents the high-level elements of an image in a latent space. For example, the high-level elements may include overall structure, background, foreground, scene, and/or objects. In some cases, the intermediate feature is represented as a vector in a latent space (e.g., a high-dimensional space). In the early stage of the reverse diffusion process, the intermediate feature transforms from noise into more specific and coherent features. In the mid stage of the reverse diffusion process, the intermediate feature represent a mixture of visual elements/characteristics, such as vague outline of an object, a hint of color distribution, or a rough texture pattern.

At operation 615, the system generates, using a second image generation model, a synthetic image based on the intermediate output, where the synthetic image includes the image attribute based on the level indicated by the adherence parameter. In some cases, the operations of this step refer to, or may be performed by, a second image generation model as described with reference to FIGS. 7 and 8. In some cases, the synthetic image depicts the element described by a text prompt. In some cases, the synthetic image depicts elements having a level of adherence indicated by the adherence parameter.

### System Architecture

In FIGS. 7-11 and 14, an apparatus and system for image processing include at least one processor; at least one memory storing instructions executable by the at least one processor; a first image generation model comprising parameters stored in the at least one memory and trained to generate an intermediate image based on a structure input; and a second image generation model comprising parameters stored in the at least one memory and trained to generate an output image, where the second image generation model is configured to generate the output image based on the intermediate image and an adherence parameter, and where the output image depicts an object with a structure based on the structure input.

According to some embodiments, an apparatus, system, and method for image processing are described. One or more aspects of the apparatus, system, and method include at least one processor; at least one memory storing instructions executable by the at least one processor; a first image generation model comprising parameters stored in the at least one memory and trained to generate an intermediate image based on a structure input; and a second image generation model comprising parameters stored in the at least one memory and trained to generate an output image, where the second image generation model is configured to generate the output image based on the intermediate image and a adherence parameter, and where the output image depicts an object with a structure based on the structure input.

In some aspects, the first image generation model and the second image generation model are diffusion models. In some aspects, the first image generation model comprises a UNet architecture. In some aspects, the first image generation model comprises a ControlNet architecture. Some examples of the apparatus, system, and method further include a user interface comprising a structural adherence control element. Some examples of the apparatus, system, and method further include a 3D modeling application configured to generate a 3D model, where the structure input is based on the 3D model.

FIG. 7 shows an example of an image processing apparatus 700 according to aspects of the present disclosure. The example shown includes image processing apparatus 700, processor unit 705, I/O module 710, and memory unit 715. In one aspect, memory unit 715 includes machine learning model 720, first image generation model 725, and second image generation model 730.

According to some embodiments of the present disclosure, image processing apparatus 700 includes a computer-implemented artificial neural network (ANN). An ANN is a hardware or a software component that includes a number of connected nodes (e.g., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of its inputs. In some examples, nodes may determine the output using other mathematical algorithms (e.g., selecting the max from the inputs as the output) or any other suitable algorithm for activating the node. Each node and edge is associated with one or more node weights that determine how the signal is processed and transmitted. Image processing apparatus 700 is an example of, or includes aspects of, the corresponding element described with reference to FIG. 1.

Processor unit 705 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or any combination thereof). In some cases, processor unit 705 is configured to operate a memory array using a memory controller. In other cases, a memory controller is integrated into the processor. In some cases, processor unit 705 is configured to execute computer-readable instructions stored in a memory to perform various functions. In some embodiments, processor unit 705 includes special-purpose components for modem processing, baseband processing, digital signal processing, or transmission processing. Processor unit 705 is an example of, or includes aspects of, the processor described with reference to FIG. 14.

I/O module 710 (e.g., an input/output interface) may include an I/O controller. An I/O controller may manage input and output signals for a device. I/O controller may also manage peripherals not integrated into a device. In some cases, an I/O controller may represent a physical connection or port to an external peripheral. In some cases, an I/O controller may utilize an operating system such as iOS®, ANDROID®, MS-DOS®, MS-WINDOWS®, OS/2®, UNIX®, LINUX®, or another known operating system. In other cases, an I/O controller may represent or interact with a modem, a keyboard, a mouse, a touchscreen, or a similar device. In some cases, an I/O controller may be implemented as part of a processor. In some cases, a user may interact with a device via an I/O controller or via hardware components controlled by an I/O controller.

In some examples, I/O module 710 includes a user interface. A user interface may enable a user to interact with a device. In some embodiments, the user interface may include an audio device, such as an external speaker system, an external display device such as a display screen, or an input device (e.g., a remote-control device interfaced with the user interface directly or through an I/O controller module). In some cases, a user interface may be a graphical user interface (GUI). In some examples, a communication interface operates at the boundary between communicating entities and the channel and may also record and process communications. A communication interface is provided herein to enable a processing system coupled to a transceiver (e.g., a transmitter and/or a receiver). In some examples, the transceiver is configured to transmit (or send) and receive signals for a communications device via an antenna. I/O module 710 is an example of, or includes aspects of, the I/O interface described with reference to FIG. 14.

Examples of memory unit 715 include random access memory (RAM), read-only memory (ROM), or a hard disk. Examples of memory unit 715 include solid-state memory and a hard disk drive. In some examples, memory unit 715 is used to store computer-readable, computer-executable software including instructions that, when executed, cause a processor to perform various functions described herein.

In some cases, memory unit 715 includes, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within memory unit 715 store information in the form of a logical state.

According to some aspects, memory unit 715 includes machine learning model 720, first image generation model 725, and second image generation model 730. In one aspect, machine learning model 720 includes the first image generation model 725 and second image generation model 730. Memory unit 715 is an example of, or includes aspects of, the memory subsystem described with reference to FIG. 14.

In some cases, a machine learning model 720 is a computational algorithm, model, or system designed to recognize patterns, make predictions, or perform a specific task (for example, image processing) without being explicitly programmed. According to some aspects, the machine learning model 720 is implemented as software stored in memory unit 715 and executable by processor unit 705, as firmware, as one or more hardware circuits, or as a combination thereof.

According to some embodiments of the present disclosure, the machine learning model 720 includes an ANN, which is a hardware or a software component that includes a number of connected nodes (e.g., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of its inputs. In some examples, nodes may determine the output using other mathematical algorithms (e.g., selecting the max from the inputs as the output) or any other suitable algorithm for activating the node. Each node and edge is associated with one or more node weights that determine how the signal is processed and transmitted.

During the training process, the one or more node weights are adjusted to increase the accuracy of the result (e.g., by minimizing a loss function that corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on the corresponding inputs. The initial layer is known as the input layer and the last layer is known as the output layer. In some cases, signals traverse certain layers multiple times.

According to some embodiments, the machine learning model 720 includes a computer-implemented convolutional neural network (CNN). CNN is a class of neural networks commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (e.g., the receptive field). During a forward pass of the CNN, filters at each layer may be convolved across the input volume, computing the dot product between the filter and the input. During the training process, the filters may be modified so that the filters activate when the filters detect a particular feature within the input.

In one aspect, machine learning model 720 includes machine learning parameters. Machine learning parameters, also known as model parameters or weights, are variables that provide behaviors and characteristics of the machine learning model 720. Machine learning parameters can be learned or estimated from training data and are used to make predictions or perform tasks based on learned patterns and relationships in the data.

Machine learning parameters are adjusted during a training process to minimize a loss function or maximize a performance metric. The goal of the training process is to find optimal values for the parameters that enable the machine learning model 720 to make accurate predictions or perform well on the given task.

For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning parameters are used to make predictions on new, unseen data.

According to some embodiments, the machine learning model 720 includes a computer-implemented recurrent neural network (RNN). An RNN is a class of ANN in which connections between nodes form a directed graph along an ordered (e.g., a temporal) sequence. This enables an RNN to model temporally dynamic behavior such as predicting what element should come next in a sequence. Thus, an RNN is suitable for tasks that involve ordered sequences such as text recognition (where words are ordered in a sentence). In some cases, an RNN includes one or more finite impulse recurrent networks (characterized by nodes forming a directed acyclic graph), one or more infinite impulse recurrent networks (characterized by nodes forming a directed cyclic graph), or a combination thereof.

According to some embodiments, the machine learning model 720 includes a transformer (or a transformer model, or a transformer network), where the transformer is a type of neural network model used for natural language processing tasks. A transformer network transforms one sequence into another sequence using an encoder and a decoder. The encoder and decoder include modules that can be stacked on top of each other multiple times. The modules comprise multi-head attention and feed-forward layers. The inputs and outputs (target sentences) are first embedded into an n-dimensional space. Positional encoding of the different words (e.g., give each word/part in a sequence a relative position since the sequence depends on the order of its elements) is added to the embedded representation (n-dimensional vector) of each word. In some examples, a transformer network includes an attention mechanism, where the attention looks at an input sequence and decides at each step which other parts of the sequence are important. The attention mechanism involves a query, keys, and values denoted by Q, K, and V, respectively. Q is a matrix that contains the query (vector representation of one word in the sequence), K are the keys (vector representations of the words in the sequence) and V are the values, which are again the vector representations of the words in the sequence. For the encoder and decoder, multi-head attention modules, V consists of the same word sequence as Q. However, for the attention module that takes into account the encoder and the decoder sequences, V is different from the sequence represented by Q. In some cases, values in V are multiplied and summed with some attention-weights a.

In the machine learning field, an attention mechanism (e.g., implemented in one or more ANNs) is a method of placing differing levels of importance on different elements of an input. Calculating attention may involve three basic steps. First, a similarity between the query and key vectors obtained from the input is computed to generate attention weights. Similarity functions used for this process can include the dot product, splice, detector, and the like. Next, a softmax function is used to normalize the attention weights. Finally, the attention weights are weighed together with the corresponding values. In the context of an attention network, the key and value are vectors or matrices that are used to represent the input data. The key is used to determine which parts of the input the attention mechanism should focus on, while the value is used to represent the actual data being processed.

An attention mechanism is a key component in some ANN architectures, particularly ANNs employed in natural language processing (NLP) and sequence-to-sequence tasks, that enables an ANN to focus on different parts of an input sequence when making predictions or generating output. Some sequence models (such as RNNs) process an input sequence sequentially, maintaining an internal hidden state that captures information from previous steps. However, in some cases, this sequential processing leads to difficulties in capturing long-range dependencies or attending to specific parts of the input sequence.

The attention mechanism addresses these difficulties by enabling an ANN to selectively focus on different parts of an input sequence, assigning varying degrees of importance or attention to each part. The attention mechanism achieves the selective focus by considering the relevance of each input element with respect to the current state of the ANN.

The term “self-attention” refers to a machine learning model 720 in which representations of the input interact with each other to determine attention weights for the input. Self-attention can be distinguished from other attention models because the attention weights are determined at least in part by the input itself.

According to some aspects, machine learning model 720 obtains a 3D model of an object. In some examples, machine learning model 720 generates a depth map based on the 3D model, where the condition input includes the depth map and the image attribute includes a shape of the object. In some examples, machine learning model 720 determines a timestep threshold based on the adherence parameter. In some examples, machine learning model 720 computes a product of a total number of timesteps and the adherence parameter. Machine learning model 720 is an example of, or includes aspects of, the corresponding element described with reference to FIGS. 3 and 4.

According to some aspects, first image generation model 725 is implemented as software stored in memory unit 715 and executable by processor unit 705, as firmware, as one or more hardware circuits, or as a combination thereof. According to some aspects, first image generation model 725 obtains a condition input and an adherence parameter, where the condition input indicates an image attribute and the adherence parameter indicates a level of the condition input. In some examples, first image generation model 725 generates an intermediate output based on the condition input and the adherence parameter, where the intermediate output includes the image attribute.

In some examples, first image generation model 725 generates a set of layer-specific features based on the condition input. In some examples, first image generation model 725 provides the set of layer-specific features to a set of corresponding layers of the first image generation model 725, respectively. In some examples, first image generation model 725 performs a first diffusion process before the timestep threshold. In some examples, first image generation model 725 obtains a text prompt, where the synthetic image is generated based on the text prompt. First image generation model 725 is an example of, or includes aspects of, the corresponding element described with reference to FIG. 8.

According to some aspects, second image generation model 730 is implemented as software stored in memory unit 715 and executable by processor unit 705, as firmware, as one or more hardware circuits, or as a combination thereof. According to some aspects, second image generation model 730 generates a synthetic image based on the intermediate output, where the synthetic image includes the image attribute based on the level indicated by the adherence parameter. In some examples, second image generation model 730 performs a second diffusion process after the timestep threshold. Second image generation model 730 is an example of, or includes aspects of, the corresponding element described with reference to FIG. 8.

According to some embodiments, the image processing apparatus 700 may include a training component configured to train the first image generation model 725 and/or the second image generation model 730. According to some aspects, the training component is implemented as software stored in memory unit 715 and executable by processor unit 705, as firmware, as one or more hardware circuits, or as a combination thereof. According to some embodiments, the training component is implemented as software stored in a memory unit and executable by a processor in the processor unit of a separate computing device, as firmware in the separate computing device, as one or more hardware circuits of the separate computing device, or as a combination thereof. In some examples, the training component is part of another apparatus other than image processing apparatus 700 and communicates with the image processing apparatus 700. In some examples, the training component is part of image processing apparatus 700.

According to some aspects, the training component obtains training data including a structure input and a ground truth image corresponding to the structure input. In some examples, the training component trains a first image generation model 725 to generate images with a target structure based on the structure input based on the ground truth image. In some aspects, the training data includes a text description of the ground truth image and the first image generation model 725 takes the text description as input. In some examples, the training component computes a reconstruction loss based on the ground truth image. In some aspects, the first image generation model 725 and the second image generation model 730 are trained independently

FIG. 8 shows an example of a machine learning model according to aspects of the present disclosure. The example shown includes machine learning system 800, condition input 805, adherence parameter 810, first image generation model 815, layer-specific features 830, text prompt 835, noise input 840, intermediate output 845, second image generation model 850, and synthetic image 860. In one aspect, machine learning system 800 includes first image generation model 815 and second image generation model 850. In one aspect, first image generation model 815 includes ControlNet 820 and first U-Net 825. In one aspect, second image generation model 850 includes second U-Net 855.

Conventional ControlNet takes a conditioning to generate an output image. In some cases, the conditioning may be a scalar value representing depth. Conventional ControlNet predicts residual features that are added to intermediate layers of a U-Net of a diffusion model. These residual features are multiplied by a single scalar value (e.g., a scalar weight) ranging between [0,1]. For example, 0 indicates no depth guidance and 1 indicates full depth guidance. Then, the diffusion model performs a diffusion process to generate the output image. In some cases, for example, the diffusion model performs a reverse diffusion process by iteratively reducing noise from the noisy image or pure noise to obtain the output image. However, by conditioning the model with a single scalar value throughout the entire image generation process (e.g., the reverse diffusion process), the generation process is predominantly affected by the depth guidance, and thus affects the outcome of the output image. For example, the output image might not depict the correct orientation of a chair and might not align with an input condition as shown in FIG. 4.

Referring to FIG. 8, machine learning system 800 receives text prompt 835 and adherence parameter 810 and generates synthetic image 860. For example, ControlNet 820 of first image generation model 815 receives adherence parameter 810 and a condition input 805 to generate layer-specific feature 830. In some cases, adherence parameter 810 is a depth conditioning including a scalar value or a vector. In some cases, the condition input 805 is generated based on the text prompt 835. For example, the machine learning system 800 may include a 3D modeling application configured to generate the condition input 805 based on the text prompt 835. In some cases, condition input 805 may include a structure input. In some cases, the ControlNet 820 of the first image generation model 815 generates layer-specific feature 830 based on the condition input 805 and the adherence parameter 810. For example, the layer-specific feature 830 represents the structure of the object having a level of adherence aligned with the adherence parameter 810. In some cases, the layer-specific feature 830 is provided to encoding layers of the first U-Net 825 of the first image generation model 815.

In some embodiments, the first U-Net 825 of the first image generation model 815 initiates the image generation process (e.g., the reverse diffusion process) based on the noise input 840 to generate intermediate output 845. In some cases, a text prompt 835 is input into the first U-Net 825 to further guide the image generation process. In some cases, the first image generation model 815 iteratively removes noise during a reverse diffusion process to obtain a denoised output (e.g., intermediate output 845). In some embodiments, the layer-specific feature 830 is provided to encoding layers of the first U-Net 825 to further guide the image generation process of the first image generation model 815 to generate the intermediate output 845.

In some cases, intermediate output 845 includes a noisy image depicting the element described by the text prompt 835. In some cases, the intermediate output 845 may be a latent feature representing the element described by the text prompt 835. In some cases, k iterations are performed during the reverse diffusion process to obtain the intermediate output 845. In some cases, the number of iterations to be performed during the reverse diffusion process is determined based on the adherence parameter 810.

In some cases, for example, the first diffusion timestep is determined based on the adherence parameter 810. In some cases, the first diffusion timestep represents the number of iterations to be performed by the first image generation model 815. For example, the first diffusion timestep represents a range of iterations (e.g., from 1^{st} iteration to k^{th} iteration). In some cases, for example, the first diffusion timestep represents a timestep that terminates the diffusion process of the first image generation model 815. For example, the first diffusion timestep may be k^{th} iteration, which indicates that the first image generation model 815 terminates the reverse diffusion process at k^{th} iteration.

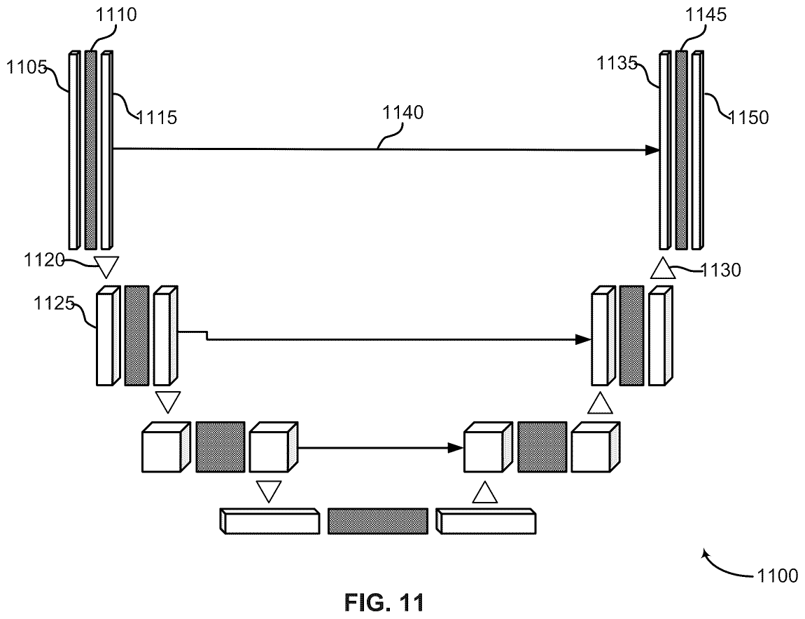

Then, the second image generation model 850 receives the intermediate output 845 as input and generates synthetic image 860. For example, second image generation model 850 includes a second U-Net 855. In some cases, the second image generation model 850 performs a reverse diffusion process on the intermediate output 845 to iteratively remove noise and generate synthetic image 860. In some embodiments, the text prompt 835 is provided to the second image generation model 850 to further guide the image generation process. For example, the text prompt 835 provides useful detailed information such as color and texture to be generated in the synthetic image 860. In one aspect, the second image generation model 850 performs T−k iterations during the reverse diffusion process, where T represents the total amount of diffusion iterations. Further details on the first U-Net 825 and the second U-Net 855 is described with reference to FIG. 11. Further detail on the reverse diffusion process is described with reference to FIG. 12.

In some cases, for example, the second image generation model 850 determines a second diffusion time step based on the adherence parameter 810. For example, the second diffusion timestep represents the number of iterations to be performed by the second image generation model 850. For example, the second diffusion timestep represents a range of iterations (e.g., from k^{th} iteration to T^{th} iteration). In some cases, for example, the second diffusion timestep represents a timestep that begins the diffusion process of the second image generation model 850. For example, the first diffusion timestep may be the k^{th} iteration or the iteration immediately after the k^{th} iteration, which indicates the second image generation model 850 to begin the reverse diffusion process and terminates at the T^{th} iteration.

According to some embodiments, the first diffusion timestep and the second diffusion timestep may be different. For example, the first diffusion timestep may be 10 iterations out of 100 total iterations (e.g., T iterations). First image generation model 815 performs 10 iterations of the diffusion process and generates intermediate output 845. Then, the second diffusion timestep may be represented as T−k iterations (e.g., 100-10 iterations). In some cases, for example, the second image generation model 850 performs 90 iterations of the diffusion process and generates synthetic image 860 based on the intermediate output 845. In some cases, for example, the second image generation model 850 begins the diffusion process at the 11^{th} diffusion step and terminates at the 100^{th} iteration. In some cases, k is less than or equal to ½T. In some cases, k is greater than or equal to ½T. In some cases, k is equal to ½T.

According to embodiments of the present disclosure, the reverse diffusion process is an iterative process that governs image generation. At every time step, a UNet ϵ_{θ}(xₜ, t, y) predicts the amount of noise in an image xₜ at a timestep t conditioned on, for example, text prompt y. The iterative process can be represented as follows:

xₜ₋₁=xₜ−ϵ_{θ}(xₜ, t, y), starting from x_{T}˜N(0, 1). In one embodiment, an additional UNet architecture κ_{Ø}(xₜ, t, y, d) that generates the image based on depth conditioning d is used. For example, the diffusion process with T iterations and depth strength s∈[0,1] can be represented as:

$${x}_{t - 1} = \{ \begin{matrix}{x}_{t} - {κ}_{∅} ( {x}_{t} , t , y , d ) , & if \frac{t}{T} < s \\ {x}_{t} - {ϵ}_{θ} ( {x}_{t} , t , y ) , & otherwise\end{matrix} \qquad ( 1 )$$

According to some embodiments, the first image generation model 815 utilizes maximum depth guidance during a first sT iteration (sometimes referred to as the first diffusion time step) of the diffusion process. In some cases, the second image generation model 850 performs, for example, text-to-image generation for a second iteration, (1−s)T, of the diffusion process. In some cases, a second iteration includes a second diffusion timestep. In some cases, the second image generation model 850 can be conditioned on an additional conditioning, such as style and/or image. By introducing depth guidance in an early stage of the diffusion process (e.g., during the first diffusion timestep), when lower frequency information is generated, and text-to-image generation in a later stage of the diffusion process (e.g., during the second diffusion timestep), when higher frequency information is generated, embodiments of the present disclosure can generate output images that are not predominantly affected by the depth guidance. As a result, the image quality of the output images is increased.

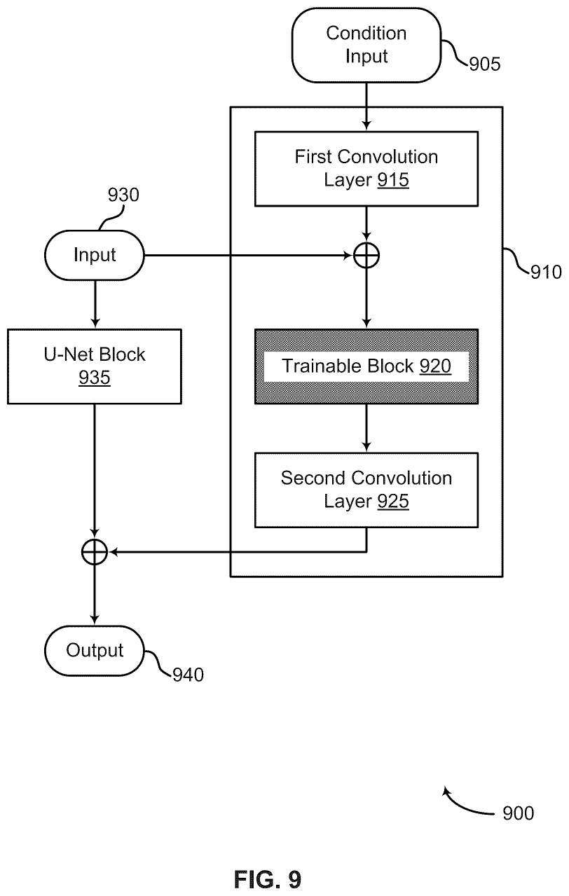

Condition input 805 is an example of, or includes aspects of, the corresponding element described with reference to FIG. 9. First image generation model 815 is an example of, or includes aspects of, the corresponding element described with reference to FIG. 7. ControlNet 820 is an example of, or includes aspects of, the corresponding element described with reference to FIG. 9.

Text prompt 835 is an example of, or includes aspects of, the corresponding element described with reference to FIGS. 3, 5, and 10. Second image generation model 850 is an example of, or includes aspects of, the corresponding element described with reference to FIG. 7. Synthetic image 860 is an example of, or includes aspects of, the corresponding element described with reference to FIG. 5.

FIG. 9 shows an example of a ControlNet architecture 900 according to aspects of the present disclosure. The example shown includes ControlNet architecture 900, condition input 905, ControlNet 910, input 930, U-Net block 935, and output 940. In one aspect, ControlNet 910 includes first convolution layer 915, trainable block 920, and second convolution layer 925.

ControlNet 910 is a neural network structure that controls image generation models by adding extra conditions. In some embodiments, a ControlNet architecture 900 copies the weights from some of the neural network blocks of the image generation model (e.g., the encoding layers of the U-Net block 935) to create a “locked” copy and a “trainable” copy. The “trainable” copy learns the condition. The “locked” copy (e.g., the U-Net block 935) preserves the parameters of the original model. The trainable copy can be tuned with a small dataset of image pairs, while preserving the locked copy ensures that the original model is preserved.

In some embodiments, one or more zero convolution layers (e.g., first convolution layer 915 and second convolution layer 925) are added to the trainable copy. A “zero convolution” layer is 1×1 convolution with both weight and bias initialized as zeros. Before training, the zero convolution layers output one or more vectors or matrices of all zeros. Accordingly, the ControlNet 910 does not cause any distortion. As the training proceeds, the parameters of the zero convolution layers deviate from zero and the influence of the ControlNet 910 as the output grows.

For example, a ControlNet architecture 900 can be used to control a diffusion U-Net (e.g., U-Net block 935), for example, to add controllable parameters or inputs that influence the output 940. Encoder layers of the U-Net block 935 can be copied and tuned. Then zero convolution layers can be added. The output of the ControlNet 910 can be input to decoder layers of the U-Net block 935.

Referring to FIG. 9, ControlNet 910 is obtained by cloning a trainable copy of a U-Net block 935. In some cases, the parameters of the U-Net block 935 are locked. ControlNet 910 is trained with an additional condition vector, for example, condition input 905. In some cases, by cloning a trainable copy of the original weights of a U-Net block 935 to generate ControlNet 910, training the copy can prevent overfitting when limited data is used. During training, condition input 905 is provided to the first convolution layer 915 of ControlNet 910. In some cases, the output from the first convolution layer 915 is combined with input 930. In some cases, for example, input 930 is a text prompt, a style prompt, a color prompt, or an image prompt. The trainable copy of the trainable block 920 is down-sampled and then upsampled through the second convolution layer(s) 925. Then, the output is input into the decoding layers of the U-Net block 935. In some cases, the output includes a plurality of layer-specific features and the plurality of layer-specific features are provided to the corresponding decoding layers of the U-Net block 935. In some cases, the output 940 is generated based on the output from ControlNet 910 and the output from the U-Net block 935. In some cases, the output 940 includes one or more elements of the input 930 and one or more elements of the condition input 905.

Condition input 905 is an example of, or includes aspects of, the corresponding element described with reference to FIG. 8. ControlNet 910 is an example of, or includes aspects of, the corresponding element described with reference to FIG. 8. ControlNet architecture 900 is an example of the first image generation model described with reference to FIG. 8.

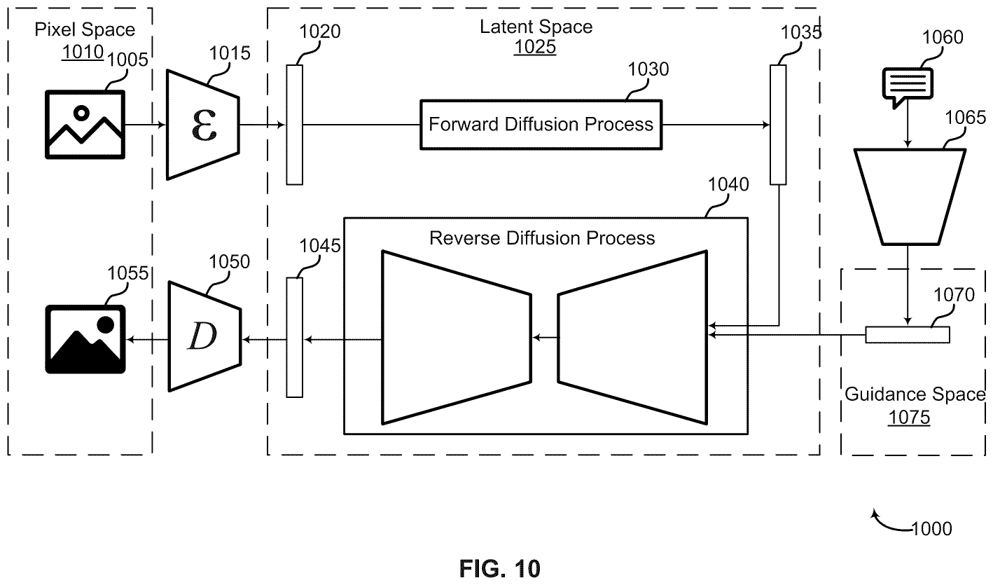

FIG. 10 shows an example of an image generation model according to aspects of the present disclosure. The example shown includes diffusion model 1000, original image 1005, pixel space 1010, image encoder 1015, original image feature 1020, latent space 1025, forward diffusion process 1030, noisy feature 1035, reverse diffusion process 1040, denoised image feature 1045, image decoder 1050, output image 1055, text prompt 1060, text encoder 1065, guidance feature 1070, and guidance space 1075. In some examples, diffusion model 1000 describes the operation and architecture of the first image generation model 725 and the second image generation model 730 described with reference to FIG. 7.

Diffusion models are a class of generative neural networks that can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance, color guidance, style guidance, and image guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (e.g., latent diffusion).

Diffusion models work by iteratively adding noise to the data during a forward process and then learning to recover the data by denoising the data during a reverse process. For example, during training, diffusion model 1000 may take an original image 1005 in a pixel space 1010 as input and apply an image encoder 1015 to convert original image 1005 into original image feature 1020 in a latent space 1025. Then, a forward diffusion process 1030 gradually adds noise to the original image feature 1020 to obtain noisy feature 1035 (also in latent space 1025) at various noise levels.

Next, a reverse diffusion process 1040 (e.g., a U-Net ANN) gradually removes the noise from the noisy feature 1035 at the various noise levels to obtain the denoised image feature 1045 in latent space 1025. In some examples, denoised image feature 1045 is compared to the original image feature 1020 at each of the various noise levels, and parameters of the reverse diffusion process 1040 of the diffusion model are updated based on the comparison. Finally, an image decoder 1050 decodes the denoised image feature 1045 to obtain an output image 1055 in pixel space 1010. In some cases, an output image 1055 is created at each of the various noise levels. The output image 1055 can be compared to the original image 1005 to train the reverse diffusion process 1040. In some cases, output image 1055 refers to the synthetic image (e.g., described with reference to FIGS. 3-4, and 7).

In some cases, image encoder 1015 and image decoder 1050 are pre-trained prior to training the reverse diffusion process 1040. In some examples, image encoder 1015 and image decoder 1050 are trained jointly, or the image encoder 1015 and image decoder 1050 are fine-tuned jointly with the reverse diffusion process 1040.

The reverse diffusion process 1040 can also be guided based on a text prompt 1060, or another guidance prompt, such as an image, a layout, a style, a color, a segmentation map, etc. The text prompt 1060 can be encoded using a text encoder 1065 (e.g., a multimodal encoder) to obtain guidance feature 1070 in guidance space 1075. The guidance feature 1070 can be combined with the noisy feature 1035 at one or more layers of the reverse diffusion process 1040 to ensure that the output image 1055 includes content described by the text prompt 1060. For example, guidance feature 1070 can be combined with the noisy feature 1035 using a cross-attention block within the reverse diffusion process 1040.

Cross-attention, also known as multi-head attention, is an extension of the attention mechanism used in some ANNs, for example, for NLP tasks. In some cases, cross-attention attends to multiple parts of an input sequence simultaneously, capturing interactions and dependencies between different elements. In cross-attention, there are two input sequences: a query sequence and a key-value sequence. The query sequence represents the elements that require attention, while the key-value sequence contains the elements to attend to. In some cases, to compute cross-attention, the cross-attention block transforms (for example, using linear projection) each element in the query sequence into a “query” representation, while the elements in the key-value sequence are transformed into “key” and “value” representations.

The cross-attention block calculates attention scores by measuring the similarity between each query representation and the key representations, where a higher similarity indicates that more attention is given to a key element. An attention score indicates the importance or relevance of each key element to a corresponding query element.

The cross-attention block then normalizes the attention scores to obtain attention weights (for example, using a softmax function), where the attention weights determine how much information from each value element is incorporated into the final attended representation. By attending to different parts of the key-value sequence simultaneously, the cross-attention block captures relationships and dependencies across the input sequences, enabling the machine learning model to understand the context and generate more accurate and contextually relevant outputs.

In some examples, diffusion models are based on a neural network architecture known as a U-Net. The U-Net takes input features having an initial resolution and an initial number of channels, and processes the input features using an initial neural network layer (e.g., a convolutional network layer) to generate intermediate outputs. The intermediate outputs are then down-sampled using a down-sampling layer such that down-sampled features have a resolution less than the initial resolution and a number of channels greater than the initial number of channels.

This process is repeated multiple times, and then the process is reversed. For example, the down-sampled features are up-sampled using the up-sampling process to obtain up-sampled features. The up-sampled features can be combined with intermediate outputs having a same resolution and number of channels via a skip connection. These inputs are processed using a final neural network layer to produce output features. In some cases, the output features have the same resolution as the initial resolution and the same number of channels as the initial number of channels.

In some cases, a U-Net takes additional input features to produce conditionally generated output. For example, the additional input features may include a vector representation of an input prompt. The additional input features can be combined with the intermediate outputs within the neural network at one or more layers. For example, a cross-attention module can be used to combine the additional input features and the intermediate outputs. Further details on the U-Net is described with reference to FIG. 11.

A diffusion process may also be modified based on conditional guidance. In some cases, a user provides a text prompt (e.g., text prompt 1060) describing content to be included in a generated image. In some examples, guidance can be provided in a form other than text, such as via an image, a sketch, a color, a style, or a layout. The system converts text prompt 1060 (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

A noise map is initialized that includes random noise. The noise map may be in a pixel space or a latent space. By initializing an image with random noise, different variations of an image including the content described by the conditional guidance can be generated. Then, the diffusion model 1000 generates an image based on the noise map and the conditional guidance vector.

A diffusion process can include both a forward diffusion process 1030 for adding noise to an image (e.g., original image 1005) or features (e.g., original image feature 1020) in a latent space 1025 and a reverse diffusion process 1040 for denoising the images (or features) to obtain a denoised image (e.g., output image 1055). The forward diffusion process 1030 can be represented as q(xₜ|xₜ₋₁), and the reverse diffusion process 1040 can be represented as p_{θ}(xₜ₋₁|xₜ). Further detail on the diffusion process is described with reference to FIG. 12.

A diffusion model 1000 may be trained using both a forward diffusion process 1030 and a reverse diffusion process 1040. In one example, the user initializes an untrained model. Initialization can include defining the architecture of the model and establishing initial values for the model parameters. In some cases, the initialization can include defining hyper-parameters such as the number of layers, the resolution and channels of each layer block, the location of skip connections, and the like.

The system then adds noise to a training image using a forward diffusion process 1030 in N stages. In some cases, the forward diffusion process 1030 is a fixed process where Gaussian noise is successively added to an image. In latent diffusion models, the Gaussian noise may be successively added to features (e.g., original image feature 1020) in a latent space 1025.

At each stage n, starting with stage N, a reverse diffusion process 1040 is used to predict the image or image features at stage n−1. For example, the reverse diffusion process 1040 can predict the noise that was added by the forward diffusion process 1030, and the predicted noise can be removed from the image to obtain the predicted image. In some cases, an original image 1005 is predicted at each stage of the training process.

The training component (e.g., training component described with reference to FIG. 6) compares predicted image (or image features) at stage n−1 to an actual image (or image features), such as the image at stage n−1 or the original input image. For example, given observed data x, the diffusion model 1000 may be trained to minimize the variational upper bound of the negative log-likelihood −log p₇₄ (x) of the training data. The training component then updates parameters of the diffusion model 1000 based on the comparison. For example, parameters of a U-Net may be updated using gradient descent. Time-dependent parameters of the Gaussian transitions can also be learned. Further details on training the diffusion model is described with reference to FIG. 13.

Original image 1005 is an example of, or includes aspects of, the corresponding element described with reference to FIG. 12. Forward diffusion process 1030 is an example of, or includes aspects of, the corresponding element described with reference to FIG. 12. Reverse diffusion process 1040 is an example of, or includes aspects of, the corresponding element described with reference to FIG. 12. Text prompt 1060 is an example of, or includes aspects of, the corresponding element described with reference to FIGS. 3, 5, and 8.

FIG. 11 shows an example of a U-Net 1100 architecture according to aspects of the present disclosure. The example shown includes U-Net 1100, input feature 1105, initial neural network layer 1110, intermediate output 1115, down-sampling layer 1120, down-sampled feature 1125, up-sampling process 1130, up-sampled feature 1135, skip connection 1140, final neural network layer 1145, and output feature 1150.

In some examples, U-Net 1100 is an example of the component that performs the reverse diffusion process 1040 of diffusion model 1000 described with reference to FIG. 10 and includes architectural elements of the first image generation model 725 and the second image generation model 730 described with reference to FIG. 7. The U-Net 1100 depicted in FIG. 11 is an example of, or includes aspects of, the architecture used within the reverse diffusion process described with reference to FIG. 10.

In some examples, diffusion models are based on a neural network architecture known as a U-Net. The U-Net 1100 takes input feature 1105 having an initial resolution and an initial number of channels and processes the input feature 1105 using an initial neural network layer 1110 (e.g., a convolutional network layer) to produce intermediate output 1115. The intermediate output 1115 is then down-sampled using a down-sampling layer 1120 such that the down-sampled feature 1125 has a resolution less than the initial resolution and a number of channels greater than the initial number of channels.

This process is repeated multiple times, and then the process is reversed. For example, the down-sampled feature 1125 is up-sampled using up-sampling process 1130 to obtain up-sampled feature 1135. The up-sampled feature 1135 can be combined with intermediate output 1115 having the same resolution and number of channels via a skip connection 1140. These inputs are processed using a final neural network layer 1145 to produce output feature 1150. In some cases, the output feature 1150 has the same resolution as the initial resolution and the same number of channels as the initial number of channels.

In some cases, U-Net 1100 takes an additional input feature to produce conditionally generated output. For example, the additional input feature could include a vector representation of an input prompt. The additional input feature can be combined with the intermediate output 1115 within the neural network at one or more layers. For example, a cross-attention module can be used to combine the additional input features and the intermediate output 1115.

### Diffusion Processing

FIG. 12 shows an example of a diffusion process 1200 according to aspects of the present disclosure. The example shown includes diffusion process 1200, forward diffusion process 1205, reverse diffusion process 1210, noisy image 1215, first intermediate image 1220, second intermediate image 1225, and original image 1230.

Diffusion process 1200 can include forward diffusion process 1205 for adding noise to original image 1230 (e.g., original image 1005 described with reference to FIG. 10) or features (e.g., original image feature 1020 described with reference to FIG. 10) in a latent space. In some aspects, diffusion process 1200 includes reverse diffusion process 1210 for denoising the noisy image 1215 (or image features) to obtain a denoised image (or original image 1230). The forward diffusion process 1205 can be represented as q(xₜ|xₜ₋₁), and the reverse diffusion process 1210 can be represented as p₇₄ (xₜ₋₁|xₜ). In some cases, the forward diffusion process 1205 is used during training to generate images with successively greater noise, and a neural network is trained to perform the reverse diffusion process 1210 (e.g., to successively remove the noise).

In an example forward diffusion process 1205 for a latent diffusion model (e.g., diffusion model 1000 described with reference to FIG. 10), the diffusion model maps an observed variable x₀ (either in a pixel space or a latent space) to obtain intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse diffusion process 1210. During the reverse diffusion process 1210, the diffusion model begins with noisy data x_{T}, such as a noisy image 1215 and denoises the data to obtain the p₇₄ (xₜ₋₁|xₜ). At each step t−1, the reverse diffusion process 1210 takes xₜ, such as the first intermediate image 1220, and t as input. Here, t represents a step in the sequence of transitions associated with different noise levels, The reverse diffusion process 1210 outputs xₜ₋₁, such as the second intermediate image 1225, iteratively until x_{T} is reverted back to x₀, the original image 1230. The reverse diffusion process 1210 can be represented as:

$${p}_{θ} ( {x}_{t - 1} \vert {x}_{t} ) := N ( {x}_{t - 1} ; {μ}_{θ} ( {x}_{t} , t ) , {Σ}_{θ} ( {x}_{t} , t ) ) . \qquad ( 2 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 3 )$$

where p(x_{T})=N(x_{T}; 0, 1) is the pure noise distribution as the reverse diffusion process 1210 takes the outcome of the forward diffusion process 1205, a sample of pure noise, as input and Πₜ₌₁^{T}p_{θ}(xₜ₋₁|xₜ) represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input image with low image quality, latent variables x₁, . . . , x_{T} represent noisy images, and \tilde{x} represents the generated image with high image quality.

Forward diffusion process 1205 is an example of, or includes aspects of, the corresponding element described with reference to FIG. 10. Reverse diffusion process 1210 is an example of, or includes aspects of, the corresponding element described with reference to FIG. 10. Original image 1230 is an example of, or includes aspects of, the corresponding element described with reference to FIG. 10.

### Training and Evaluation

In FIG. 13, a method, apparatus, non-transitory computer readable medium, and system for image processing are described. One or more aspects of the method, apparatus, non-transitory computer readable medium, and system include obtaining training data including a structure input and a ground truth image corresponding to the structure input; training a first image generation model to generate images with a target structure based on the structure input based on the ground truth image; and generating, using a second image generation model, an output image, where an output of the first image generation model is used as input of the second image generation model.

Some examples of the method, apparatus, non-transitory computer readable medium, and system further include obtaining a 3D model. Some examples further include generating a depth map based on the 3D model, where the structure input comprises the depth map. In some aspects, the training data includes a text description of the ground truth image and the first image generation model takes the text description as input.

Some examples of the method, apparatus, non-transitory computer readable medium, and system further include performing a forward diffusion process on the ground truth image to obtain a noisy image. Some examples further include performing a reverse diffusion process on the noisy image. Some examples of the method, apparatus, non-transitory computer readable medium, and system further include computing a reconstruction loss based on the ground truth image. In some aspects, the first image generation model and the second image generation model are trained independently.

FIG. 13 shows an example of a method 1300 for training a diffusion model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

In some embodiments, the method 1300 describes an operation of the training component for training the first image generation model 725 and the second image generation model 730 as described with reference to FIG. 7. The method 1300 represents an example for training a reverse diffusion process as described above with reference to FIG. 12. In some examples, these operations are performed by a system including a processor executing a set of codes to control functional elements of an apparatus, such as the first image generation model 725 or the second image generation model 730 described in FIG. 7.

At operation 1305, the system initializes untrained model. In some cases, the operations of this step refer to, or may be performed by, a training component as described with reference to FIG. 7. Initialization can include defining the architecture of the model and establishing initial values for the model parameters. In some cases, the initialization can include defining hyper-parameters such as the number of layers, the resolution and channels of each layer block, the location of skip connections, and the like.

At operation 1310, the system adds noise to media item using forward diffusion process in N stages. In some cases, the operations of this step refer to, or may be performed by, a training component as described with reference to FIG. 7. In some cases, for example, the media item is a training image. In some cases, the forward diffusion process is a fixed process where Gaussian noise is successively added to the media item (such as an original image). In latent diffusion models, the Gaussian noise may be successively added to features in a latent space.

At operation 1315, the system at each stage n, starting with stage N, predict media item for stage n−1. In some cases, the operations of this step refer to, or may be performed by, a training component as described with reference to FIG. 7. In some cases, the media item is a synthetic image generated using the image generation model. For example, the reverse diffusion process can predict the noise that was added by the forward diffusion process, and the predicted noise can be removed from the noise input to obtain the predicted output. In some cases, an original media item is predicted at each stage of the training process.

At operation 1305, the system compares the predicted media item (or feature) at stage n−1 to media at stage n−1. In some cases, for example, the system compares the synthetic image (or predicted image feature) at state n−1 to the ground-truth image (or ground-truth feature) at state n−1. In some cases, the operations of this step refer to, or may be performed by, a training component as described with reference to FIG. 7. For example, given observed data x, the diffusion model may be trained to minimize the variational upper bound of the negative log-likelihood −log p₇₄ (x) of the training data.

At operation 1325, the system updates parameters of the model based on the comparison. In some cases, the operations of this step refer to, or may be performed by, a training component as described with reference to FIG. 7. For example, parameters of a U-Net may be updated using gradient descent. Time-dependent parameters of the Gaussian transitions can also be learned.

### Computing Device

FIG. 14 shows an example of a computing device 1400 according to aspects of the present disclosure. The example shown includes computing device 1400, processor 1405, memory subsystem 1410, communication interface 1415, I/O interface 1420, user interface component 1425, and channel 1430.

In some embodiments, computing device 1400 is an example of, or includes aspects of, the image processing apparatus described with reference to FIGS. 1 and 7. In some embodiments, computing device 1400 includes processor 1405 that can execute instructions stored in memory subsystem 1410 to obtain a condition input and an adherence parameter, generate an intermediate output based on the condition input and the adherence parameter, and generate a synthetic image based on the intermediate output.

According to some embodiments, processor 1405 includes one or more processors. In some cases, processor 1405 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or a combination thereof. In some cases, processor 1405 is configured to operate a memory array using a memory controller. In other cases, a memory controller is integrated into processor 1405. In some cases, processor 1405 is configured to execute computer-readable instructions stored in a memory to perform various functions. In some embodiments, processor 1405 includes special-purpose components for modem processing, baseband processing, digital signal processing, or transmission processing. Processor 1405 is an example of, or includes aspects of, the processor unit described with reference to FIG. 7.

According to some embodiments, memory subsystem 1410 includes one or more memory devices. Examples of a memory device include random access memory (RAM), read-only memory (ROM), or a hard disk. Examples of memory devices include solid-state memory and a hard disk drive. In some examples, memory is used to store computer-readable, computer-executable software including instructions that, when executed, cause a processor to perform various functions described herein. In some cases, the memory contains, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within a memory store information in the form of a logical state. Memory subsystem 1410 is an example of, or includes aspects of, the memory unit described with reference to FIG. 7.

According to some embodiments, communication interface 1415 operates at a boundary between communicating entities (such as computing device 1400, one or more user devices, a cloud, and one or more databases) and channel 1430 and can record and process communications. In some cases, communication interface 1415 is provided to enable a processing system coupled to a transceiver (e.g., a transmitter and/or a receiver). In some examples, the transceiver is configured to transmit (or send) and receive signals for a communications device via an antenna. In some cases, a bus is used in communication interface 1415.

According to some embodiments, I/O interface 1420 is controlled by an I/O controller to manage input and output signals for computing device 1400. In some cases, I/O interface 1420 manages peripherals not integrated into computing device 1400. In some cases, I/O interface 1420 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating systems. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1420 or hardware components controlled by the I/O controller. I/O interface 1420 is an example of, or includes aspects of, the I/O module described with reference to FIG. 7.

According to some embodiments, user interface component 1425 enables a user to interact with computing device 1400. In some cases, user interface component 1425 includes an audio device, such as an external speaker system, an external display device such as a display screen, an input device (e.g., a remote-control device interfaced with a user interface directly or through the I/O controller), or a combination thereof. User interface component 1425 is an example of, or includes aspects of, the user interface described with reference to FIG. 7.

The performance of apparatus, systems, and methods of the present disclosure have been evaluated, and results indicate embodiments of the present disclosure have obtained increased performance over conventional technology (e.g., conventional image generation models). Example experiments demonstrate that the image processing apparatus based on the present disclosure outperforms conventional image generation models. Details on the example use cases based on embodiments of the present disclosure are described with reference to FIGS. 3 and 4.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the concepts described. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The methods described may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining a condition input and an adherence parameter, wherein the condition input indicates an image attribute and the adherence parameter indicates a level of the image attribute;
generating, using a first image generation model, an intermediate output based on the condition input and the adherence parameter, wherein the intermediate output represents the image attribute; and
generating, using a second image generation model, a synthetic image based on the intermediate output, wherein the synthetic image depicts the image attribute at the level indicated by the adherence parameter.

2. The method of claim 1, wherein obtaining the condition input comprises:
obtaining a 3D model of an object; and
generating a depth map based on the 3D model, wherein the condition input comprises the depth map and the image attribute comprises a shape of the object.

3. The method of claim 1, wherein generating the intermediate output comprises:
generating a plurality of layer-specific features based on the condition input; and
providing the plurality of layer-specific features to a plurality of corresponding layers of the first image generation model, respectively.

4. The method of claim 1, wherein generating the intermediate output comprises:
determining a timestep threshold based on the adherence parameter; and
performing, using the first image generation model, a first diffusion process before the timestep threshold.

5. The method of claim 4, wherein generating the synthetic image comprises:
performing, using the second image generation model, a second diffusion process after the timestep threshold.

6. The method of claim 4, wherein determining the timestep threshold comprises:
computing a product of a total number of timesteps and the adherence parameter.

7. The method of claim 1, further comprising:
obtaining a text prompt, wherein the synthetic image is generated based on the text prompt.

8. A non-transitory computer readable medium storing code for image processing, the code comprising instructions that, when executed by at least one processor, cause the at least one processor to perform operations comprising:
obtaining a condition input and an adherence parameter;
generating an intermediate output based on the condition input by performing a first diffusion process for a first number of timesteps based on the adherence parameter; and
generating a synthetic image based on the intermediate output.

9. The non-transitory computer readable medium of claim 8, wherein obtaining the condition input comprises:
obtaining a 3D model of an object; and
generating a depth map based on the 3D model.

10. The non-transitory computer readable medium of claim 8, wherein the first diffusion process comprises:
generating a plurality of layer-specific features based on the condition input; and
providing the plurality of layer-specific features to a plurality of corresponding layers of the first image generation model, respectively.

11. The non-transitory computer readable medium of claim 8, wherein the first diffusion process comprises:
determining a timestep threshold based on the adherence parameter; and
performing, using a first image generation model, the first diffusion process for the first number of timesteps until the timestep threshold is met.

12. The non-transitory computer readable medium of claim 11, wherein generating the synthetic image comprises:
performing, using a second image generation model, a second diffusion process for a second number of timesteps after the timestep threshold.

13. The non-transitory computer readable medium of claim 11, wherein determining the timestep threshold comprises:
computing a product of a total number of timesteps and the adherence parameter.

14. The non-transitory computer readable medium of claim 8, the code further comprising instructions executable by the processor to perform operations comprising:
obtaining a text prompt, wherein the synthetic image is generated based on the text prompt.

15. A system comprising:
a memory component; and
a processing device coupled to the memory component, the processing device configured to perform operations comprising:
obtaining a condition input and an adherence parameter, wherein the condition input indicates an image attribute and the adherence parameter indicates a level of the image attribute;
generating, using a first image generation model, an intermediate output based on the condition input and the adherence parameter, wherein the intermediate output includes the image attribute; and
generating, using a second image generation model, a synthetic image based on the intermediate output, wherein the synthetic image includes the image attribute based on the level indicated by the adherence parameter.

16. The system of claim 15, wherein obtaining the condition input comprises:
obtaining a 3D model of an object; and
generating a depth map based on the 3D model, wherein the condition input comprises the depth map and the image attribute comprises a shape of the object.

17. The system of claim 15, wherein generating the intermediate output comprises:
generating a plurality of layer-specific features based on the condition input; and
providing the plurality of layer-specific features to a plurality of corresponding layers of the first image generation model, respectively.

18. The system of claim 15, wherein generating the intermediate output comprises:
determining a timestep threshold based on the adherence parameter; and
performing, using the first image generation model, a first diffusion process before the timestep threshold.

19. The system of claim 18, wherein generating the synthetic image comprises:
performing, using the second image generation model, a second diffusion process after the timestep threshold.

20. The system of claim 18, wherein determining the timestep threshold comprises:
computing a product of a total number of timesteps and the adherence parameter.
